(19) United States
(12) Patent Application Publication
(10) Pub. No.: US 2026/0331404 A1
(43) Pub. Date: Oct. 22, 2026

(54) CIRCUIT BREAKER

(71) Applicant: Osaka Sangyo University, Osaka (JP)

(72) Inventor: Akihiko IWATA, Osaka (JP)

(73) Assignee: Osaka Sangyo University, Osaka (JP)

(21) Appl. No.: 19/104,339

(22) PCT Filed: Jul. 27, 2023
(86) PCT No.: PCT/JP2023/027631

§ 371 Date: Feb. 17, 2025

(30) Foreign Application Priority Data
Aug. 19, 2022 (JP) 2022-131243

(51) Int. Cl. H01H 33/59; H01H 9/54

(52) U.S. Cl. CPC H01H 33/596; H01H 9/542; H01H 2009/544

(57) ABSTRACT

A circuit breaker 1 includes: a first circuit C1 including a first bidirectional semiconductor switch S1; and a second circuit C2 including a second bidirectional semiconductor switch S2. In the first circuit C1, a mechanical switch M1 connected in series with the first bidirectional semiconductor switch S1 is provided. During normal operation, the first bidirectional semiconductor switch S1 and the first mechanical switch M1 are turned on to pass a normal current through the first circuit C1. When a fault occurs in the load 2, the first bidirectional semiconductor switch S1 is turned off to interrupt an overcurrent. When a fault occurs in the first bidirectional semiconductor switch S1, the first mechanical switch M1 is opened to pass the normal current for the load 2 through the second circuit C2.

### TECHNICAL FIELD

The present invention relates to a circuit breaker including a switch constituted by a semiconductor device.

### BACKGROUND ART

A well-known example of research and development in power-source grids is N3-X from NASA (Non-Patent Document 1). An electrified aircraft such as N3-X has a grid system configured such that, even when some of its devices have a fault, operation can be continued using the remaining sound devices by quickly disconnecting the fault points and switch connection. In such a grid system including a switching configuration, a current-limiting circuit breaker that prevents and disconnects a fault current is a crucial part. For example, since direct current (DC) power supply is contemplated for a grid system for an electrified aircraft, a DC circuit breaker that interrupts direct current is deemed to be an important part. The waveform of DC current, unlike that of AC current, does not cross the zero point; as such, interruption of DC current often proves difficult compared with that for AC.

In research on DC-current-limiting circuit breakers, the field of microgrids mainly using renewable energy is leading the way (Non-Patent Document 2). Non-Patent Document 2 introduces seven types of DC circuit breakers. One of the types described therein is a conventional hybrid circuit breaker shown in FIG. 4, which includes a mechanical switch, a semiconductor branch and a varistor connected in parallel. In this circuit breaker, during normal operation, the electric current flows through the mechanical switch. When a fault is detected, the mechanical switch is opened such that the arc voltage is used to commutate the current from the mechanical switch to the semiconductor branch. The semiconductors conduct the current until the mechanical switch blocks the full system voltage. Thereafter, the semiconductors are turned off, and the varistor conducts to keep the voltage across the circuit breaker at a constant level. In this type, the switching speed strongly depends on the mechanical switch.

Further, FIG. 6 of Non-Patent Document 2 shows a proactive hybrid DC circuit breaker. This DC circuit breaker includes two branches connected in parallel. The first branch includes a mechanical switch, which represents the current path during normal operation, and a group of semiconductor switches that represent a load commutation switch (LCS), connected in series. The second branch includes a group of semiconductor switches, which represent the main breaker, connected in series. During normal operation, the mechanical switch and LCS are on, and the group of semiconductor switches representing the main breaker are off. When a fault is detected, the LCS is turned off, and the group of semiconductor switches representing the main breaker are turned on. The snubber circuit of the LCS charges and produces a voltage that allows current to flow from the mechanical switch into the main breaker. When all the current is flowing through the main breaker, the mechanical switch is opened. Since the current is substantially zero, the mechanical switch is opened at high speed. Subsequently, the group of semiconductor switches of the main breaker are turned off. In this type, by virtue of the LCS, commutation to the group of semiconductor switches in the main breaker is performed in advance (i.e., proactively), thereby compensating for the delay of the mechanical switch. A circuit breaker with a similar configuration is described in WO 2011/057675 A1 (Patent Document 1).

### PRIOR ART DOCUMENTS

### Patent Documents

Patent Document 1: WO 2011/057675 A1

### Non-Patent Documents

Non-Patent Document 1:“Stability, Transient Response, Control, and Safety of a High-Power Electric Grid for Turboelectric Propulsion of Aircraft”, NASA/CR-2013-217865

Non-Patent Document 2: X. Pei, et al., “A Review of Technologies for MVDC Circuit Breakers”, IECON 2016—42nd Annual Conference of the IEEE Industrial Electronics Society

### SUMMARY OF THE INVENTION

### Problems to Be Solved by the Invention

A fault in a circuit breaker may have a catastrophic effect on the system. For example, in an electrified aircraft, circuit breakers are used in crucial portions relating to operation, such as propulsion system. In view of this, a circuit breaker, which, when a fault occurs, is deemed to cause a “catastrophic” degree of effect on the aircraft, may be required to have a design assurance level (DAL) of “A”. If this is the case, the circuit breaker is required to have a fault rate for its interrupting function of less than 10\hat{ }-9/hour. In other words, it is required that the probability of the circuit breaker being unable to interrupt a short-circuit current in the load per hour be lower than 10\hat{ }-9/hour. The above-mentioned documents hardly discuss a fault in the current-limiting circuit breaker.

For example, in the above-discussed conventional hybrid circuit breaker, achieving a fault rate for its interrupting function of lower than 10\hat{ }-9/hour requires that both the product of the fault rate of the mechanical switch and the fault rate of the load and the product of the fault rate of the semiconductors and the fault rate of the load be less than 10\hat{ }-9/hour. Since a large number of semiconductors are used in a load, a load usually has a fault rate about lower than 10\hat{ }-4/hour. In this case, the fault rate of the mechanical switch and semiconductors must be lower than 10\hat{ }-5/hour. To ensure that the mechanical switch has a fault rate lower than 10\hat{ }-5/hour, the switch must be constructed with robust movable parts and reduced wear of the contact points, for example. In such cases, the mechanical switch will be large and heavy weight.

Further, in the above-discussed conventional hybrid circuit breaker, the interruption time from the detection of a fault in the load until the semiconductors are turned off is determined by the sum of the operation time of the mechanical switch and the recovery time until insulation.

According to documents and outer sources, the interruption time is to be approximately 500 microseconds. If the interruption time is approximately 500 microseconds, a large current-limiting inductor is needed upstream or downstream of the circuit breaker to reduce a rising short circuit current in the load. This leads to an increased weight of the entire system.

In view of this, an object of the present disclosure is to provide a circuit breaker that enables reducing the fault rate for its interrupting function while reducing weight.

### Means for Solving the Problem

A circuit breaker according to an embodiment of the present invention is a circuit breaker connected to a load. The circuit breaker includes: a first circuit including a first bidirectional semiconductor switch; and a second circuit connected in parallel with the first circuit and including a second bidirectional semiconductor switch.

At least the first circuit out of the first circuit or the second circuit includes a first mechanical switch connected in series with the first bidirectional semiconductor switch.

During normal operation, the first bidirectional semiconductor switch and the first mechanical switch are turned on to pass a normal current through the first circuit.

When a fault occurs in the load, the first bidirectional semiconductor switch is turned off to interrupt an overcurrent.

When a fault occurs in the first bidirectional semiconductor switch, the first mechanical switch is opened to pass the normal current for the load through the second circuit.

### BRIEF DESCRIPTION OF THE DRAWINGS

FIG. 1 shows an exemplary configuration of a circuit breaker according to Embodiment 1.

FIG. 2 shows an exemplary configuration of a circuit breaker according to Embodiment 2.

FIG. 3 shows an exemplary configuration of a circuit breaker according to Embodiment 3.

FIG. 4 shows an exemplary configuration of a circuit breaker according to Embodiment 4.

FIG. 5 illustrates an exemplary operation of the circuit breaker shown in FIG. 4.

FIG. 6 shows an exemplary configuration of a circuit breaker according to Embodiment 5.

FIG. 7 illustrates an exemplary operation of the circuit breaker shown in FIG. 6.

FIG. 8 shows an exemplary configuration of a DC grid system according to an embodiment.

### EMBODIMENTS FOR CARRYING OUT THE INVENTION

### Arrangement 1

A circuit breaker according to an embodiment of the present invention is a circuit breaker connected to a load. The circuit breaker includes: a first circuit including a first bidirectional semiconductor switch; and a second circuit connected in parallel with the first circuit and including a second bidirectional semiconductor switch.

At least the first circuit out of the first circuit or the second circuit includes a first mechanical switch connected in series with the first bidirectional semiconductor switch.

During normal operation, the first bidirectional semiconductor switch and the first mechanical switch are turned on to pass a normal current through the first circuit.

When a fault occurs in the load, the first bidirectional semiconductor switch is turned off to interrupt an overcurrent.

When a fault occurs in the first bidirectional semiconductor switch, the first mechanical switch is opened to pass the normal current for the load through the second circuit.

In Arrangement 1 above, a first mechanical switch is connected in series with a first bidirectional semiconductor switch, i.e., at least one of bidirectional semiconductor switches connected in parallel. The normal current during normal operation flows through the first mechanical switch. When a fault in the load is detected, the first bidirectional semiconductor switch connected in series with the first mechanical switch is turned off to interrupt the overcurrent caused by the fault in the load (e.g., short-circuit current). This reduces the interruption time compared with interruption using a mechanical switch. This enables reducing the size and weight of an inductor provided upstream or downstream to limit current. Further, with this arrangement, even when faults occur in the load and first mechanical switch simultaneously, the overcurrent can be blocked by turning off the first bidirectional semiconductor switch. Further, when a fault occurs in the first bidirectional semiconductor switch alone, the first mechanical switch may be opened to pass the normal current through the second circuit. Thus, Arrangement 1 provides a fail-safe function for simultaneous faults in the first mechanical switch and load, for a fault in the first mechanical switch alone, and for a fault in the first bidirectional semiconductor switch alone. This enables reducing the level of fault rate of the first mechanical switch required to achieve the fault rate for the interrupting function required of the circuit breaker. This enables reducing the weight of the first mechanical switch. As a result, the fault rate for the interrupting function can be reduced while reducing the weight of the circuit breaker.

The bidirectional semiconductor switch may be a bidirectional switch constituted by a semiconductor switching device, for example. The semiconductor switching device used may be, for example, an insulated-gate bipolar transistor (IGBT), an integrated gate-commutated thyristor (IGCT), or metal-oxide-semiconductor field-effect transistor (MOSFET). For example, a bidirectional semiconductor switch may be constituted by two semiconductor transistors with their sources connected together.

### Arrangement 2

Starting from Arrangement 1 above, the second circuit may be configured so as not to include a mechanical switch connected in series with the second bidirectional semiconductor switch. In this case, during normal operation, the first bidirectional semiconductor switch and the first mechanical switch are turned on and the second bidirectional semiconductor switch is turned off to pass the normal current through the first circuit.

When a fault occurs in the load, the first bidirectional semiconductor switch is turned off to block an overcurrent.

When a fault occurs in the first bidirectional semiconductor switch, the first mechanical switch is opened to pass the normal current for the load through the second circuit, and, after insulation of the first mechanical switch recovers, the second bidirectional semiconductor switch is turned off.

Upon a fault in the first bidirectional semiconductor switch, during commutation of the normal current to the second circuit upon a fault in the first bidirectional semiconductor switch, no voltage for generating an arc is applied to the first mechanical switch. This enables reducing the size and weight of the first mechanical switch than a mechanical switch to which an arc voltage is applied.

### Arrangement 3

A circuit breaker according to an embodiment of the present invention is a circuit breaker connected to a load. The circuit breaker includes: a first circuit including a first bidirectional semiconductor switch; and a second circuit connected in parallel with the first circuit and including a second bidirectional semiconductor switch.

The first circuit may include a first mechanical switch connected in series with the first bidirectional semiconductor switch; and the second circuit may include a second mechanical switch connected in series with the second bidirectional semiconductor switch.

In Arrangement 3, the circuit breaker is configured such that branches that each include a bidirectional semiconductor switch and a mechanical switch connected in series are connected in parallel. In this arrangement, during normal operation, the normal current may be distributed among the two bidirectional semiconductor switches connected in parallel. This enables reducing the conduction losses in the semiconductors. Further, Arrangement 3 enables blocking of the overcurrent by virtue of the two bidirectional semiconductor switches upon a fault in the load and, in addition, provides a fail-safe operation for simultaneous faults in the load and mechanical switch, for a fault in the mechanical switch alone, and for a fault in the bidirectional semiconductor switch alone. Thus, the circuit breaker of Arrangement 3 enables reducing the weight and fault rate and, in addition, reducing losses to increase efficiency.

### Arrangement 4

Starting from Arrangement 3 above, in the circuit breaker,
during normal operation, the first mechanical switch and the second mechanical switch may be turned on and the first bidirectional semiconductor switch and the second bidirectional semiconductor switch may be turned on to pass the normal current through the first circuit and the second circuit.

When a fault occurs in the load, the first bidirectional semiconductor switch and the second bidirectional semiconductor switch may be turned off to block an overcurrent.

When a fault occurs in the first bidirectional semiconductor switch, the first mechanical switch may be opened to pass the normal current for the load through the second circuit, and, thereafter, either normal operation is continued or, after insulation of the first mechanical switch recovers, the second bidirectional semiconductor switch is turned off.

When a fault occurs in the second bidirectional semiconductor switch, the second mechanical switch is opened to pass the normal current for the load through the first circuit, and, thereafter, either normal operation is continued or, after insulation of the second mechanical switch recovers, the first bidirectional semiconductor switch is turned off.

### Arrangement 5

Starting from Arrangement 1 or 2, in the circuit breaker, the first circuit may include the first mechanical switch connected in series with the first bidirectional semiconductor switch; and the second circuit may include a third bidirectional semiconductor switch connected in series with the second bidirectional semiconductor switch. In such implementations, during normal operation, the first mechanical switch and the first bidirectional semiconductor switch may be turned on and the second bidirectional semiconductor switch and the third bidirectional semiconductor switch may be turned on to pass the normal current through the first circuit and the second circuit.

When a fault occurs in the load, the first bidirectional semiconductor switch, the second bidirectional semiconductor switch and the third bidirectional semiconductor switch may be turned off.

When a fault occurs in the first bidirectional semiconductor switch, the first mechanical switch may be opened to pass the normal current for the load through the second circuit, and, thereafter, either normal operation is continued or, after insulation of the first mechanical switch recovers, at least one of the second bidirectional semiconductor switch and the third bidirectional semiconductor switch is turned off.

When a fault occurs in the second bidirectional semiconductor switch, the third bidirectional semiconductor switch may be turned off to pass the normal current for the load through the first circuit to continue normal operation, or the third bidirectional semiconductor switch and the first bidirectional semiconductor switch may be turned off.

When a fault occurs in the third bidirectional semiconductor switch, the second bidirectional semiconductor switch may be turned off to pass the normal current for the load through the first circuit to continue normal operation, or the second bidirectional semiconductor switch and the first bidirectional semiconductor switch may be turned off.

In Arrangement 5, during normal operation, the normal current may be distributed among the first bidirectional semiconductor switch and the second and third bidirectional semiconductor switches. This will reduce the conduction losses in the semiconductors. Further, in Arrangement 5, when a fault occurs in the load, the first to third bidirectional semiconductor switches may be turned off to block the overcurrent. In the case of simultaneous faults in the load and first mechanical switch, and in the case of a fault in the first mechanical switch, the first to third bidirectional semiconductor switches may be similarly turned off to perform fail-safe operation. Further, fail-safe operation is possible in the case of a fault in one of the first to third bidirectional semiconductor switches alone. Thus, the circuit breaker of Arrangement 5 enables reducing the weight and fault rate and, in addition, reducing losses to increase efficiency.

### Arrangement 6

A circuit breaker according to an embodiment of the present invention is a circuit breaker connected to a load, including: a first circuit including a first bidirectional semiconductor switch; and a second circuit connected in parallel with the first circuit and including a second bidirectional semiconductor switch. The circuit breaker is designed in such a manner that: a product of a fault rate of the load and a fault rate of the first bidirectional semiconductor switch is less than 10\hat{ }-9/hour; and a product of the fault rate of the load and a fault rate of the second bidirectional semiconductor switch is less than 10\hat{ }-9/hour.

This enables reducing the fault rate for the interrupting function while reducing the weight of the circuit breaker. For example, in an arrangement where at least one of the first or second circuit includes a mechanical switch connected in series with the associated bidirectional semiconductor switch, it is possible to lower the required fault rate of the mechanical switch to achieve a fault rate for the interrupting function of lower than 10\hat{ }-9/hour. By way of example, if the fault rate of the load is lower than 10\hat{ }-4/hour and the fault rate of each of the first and second bidirectional semiconductor switches is lower than 10\hat{ }-5/hour, the fault rate, based on simultaneous faults, of each of the first and second bidirectional semiconductor switches and the mechanical switch is lower than 10\hat{ }-9/hour if the fault rate of the mechanical switch is lower than 10\hat{ }-4/hour. Since fault rate of the mechanical switch need not be lower than 10\hat{ }-5/hour, this will prevent increase of the size and weight of the mechanical switch. It will be understood that embodiments of the present invention also include a circuit breaker with an arrangement including a combination of Arrangement 6 with any one of Arrangements 1 to 5 above.

It will be understood that ensuring that the product of the fault rate of the load and the fault rate of the first bidirectional semiconductor switch is less than 10\hat{ }-9/hour is the same as designing a circuit breaker in such a manner that the probability of faults occurring in the load and the first bidirectional semiconductor switch simultaneously is lower than 10\hat{ }-9/hour.

### Arrangement 7

Starting from any one of Arrangements 1 to 6 above, the circuit breaker may include: a fault diagnosis unit adapted to regularly perform a fault diagnosis process for the first bidirectional semiconductor switch and the second bidirectional semiconductor switch.

The fault diagnosis unit is capable of detecting early a fault in the first and second bidirectional semiconductor switches. This reduces the time for which the faulty first or second bidirectional semiconductor switch resides together with another component without a fault. This significantly reduces fault rate. Adding the fault diagnosis unit does not entail a significant increase in weight. As a result, fault rate can be reduced while reducing the weight of the circuit breaker. The fault diagnosis process is a process for determining whether there is a fault in a bidirectional semiconductor switch, for example.

### Arrangement 8

Starting from Arrangement 7 above, a product of the fault rate of the load, a nominal value of the fault rate of the first bidirectional semiconductor switch and 1/K1 is less than 10\hat{ }-9/hour; and a product of the fault rate of the load, a nominal value of the fault rate of the second bidirectional semiconductor switch and 1/K2 is less than 10\hat{ }-9/hour.

Here, K1 is the number of times the fault diagnosis process for the first bidirectional semiconductor switch is performed per hour. K2 is the number of times the fault diagnosis process for the second bidirectional semiconductor switch is performed per hour.

In Arrangement 8 above, both the product of the fault rate of the load and the fault rate of the first bidirectional semiconductor switch and the product of the fault rate of the load and the fault rate of the second bidirectional semiconductor switch can be regarded as less than 10\hat{ }-9/hour. Arrangement 8 above is an example of Arrangement 7 above.

### Arrangement 9

Starting from Arrangement 5, the circuit breaker may further include: a fault diagnosis unit adapted to regularly perform a fault diagnosis process for the first bidirectional semiconductor switch, the second bidirectional semiconductor switch, and the third bidirectional semiconductor switch. This will significantly reduce the fault rate for the interrupting function.

### Arrangement 10

Starting from Arrangement 7 or 8 above, the fault diagnosis unit may be configured to successively perform, during normal operation: an operation in which the first bidirectional semiconductor switch is turned on and the second bidirectional semiconductor switch is turned off to pass the normal current through the first circuit; and an operation in which the first bidirectional semiconductor switch is turned off and the second bidirectional semiconductor switch is turned on to pass the normal current through the second circuit, and perform the fault diagnosis process based on at least one of a current in the first circuit or a current in the second circuit during the associated operation. This enables efficiently performing the fault diagnosis process.

Starting from Arrangement 9 above, the fault diagnosis unit may be configured to successively perform, during normal operation: an operation in which the first bidirectional semiconductor switch is turned on and the second bidirectional semiconductor switch is turned off to pass the normal current through the first circuit; an operation in which the first bidirectional semiconductor switch is turned on and the third bidirectional semiconductor switch is turned off to pass the normal current through the first circuit; and an operation in which the first bidirectional semiconductor switch is turned off and the second bidirectional semiconductor switch is turned on to pass the normal current through the second circuit, and perform the fault diagnosis process based on at least one of a current in the first circuit or a current in the second circuit during the associated operation. This enables efficiently performing the fault diagnosis process.

The fault diagnosis unit may be constituted by a circuit. The fault diagnosis unit may be included, for example, in a control unit (i.e., controller) that controls the first bidirectional semiconductor switch and the second bidirectional semiconductor switch between on and off. Further, the circuit breaker may include a sensor that detects current flowing through the first bidirectional semiconductor switch and the second bidirectional semiconductor switch. The fault diagnosis unit may determine whether there is a fault based on the detected current.

Starting from any one of Arrangements 6 to 10 above, the circuit breaker may be designed in such a manner that a product of the fault rate of the first bidirectional semiconductor switch and the fault rate of the second bidirectional semiconductor switch is less than 10\hat{ }-9/hour. Thus, the fault rate, based on simultaneous faults, of the first bidirectional semiconductor switch and the second bidirectional semiconductor switch will essentially be lower than 10\hat{ }-9/hour.

As used herein, fault rate means the probability of a fault per hour. The fault rate is the product of a failure in time (FIT) and 1/10\hat{ }9, where an FIT is the average number of times a fault occurs per 10\hat{ }9 hours. Here, the fault rate of a bidirectional semiconductor switch, mechanical switch, load, and other parts is a design value determined based on a nominal value provided by the supplier of the part (e.g., manufacturer) as well as on its drive design, wiring design and other design matters. It will be understood that “10\hat{ }-9” can also be expressed as “10 to the power of −9”, “1.0e-9”, “1.0E-9” or “10^{-9”.}

Starting from any one of Arrangements 6 to 10 above, the circuit breaker may be designed in such a manner that a product of the fault rate of the first bidirectional semiconductor switch and a fault rate of a first mechanical switch is less than 10\hat{ }-9/hour. Thus, the fault rate, based on simultaneous faults, of the first bidirectional semiconductor switch and the first mechanical switch will essentially be lower than 10\hat{ }-9/hour.

Starting from any one of Arrangements 6 to 10 above, the circuit breaker may be designed in such a manner that a product of the fault rate of the second bidirectional semiconductor switch and a fault rate of a second mechanical switch is less than 10\hat{ }-9/hour. Thus, the fault rate, based on simultaneous faults, of the second bidirectional semiconductor switch and the second mechanical switch will essentially be lower than 10\hat{ }-9/hour.

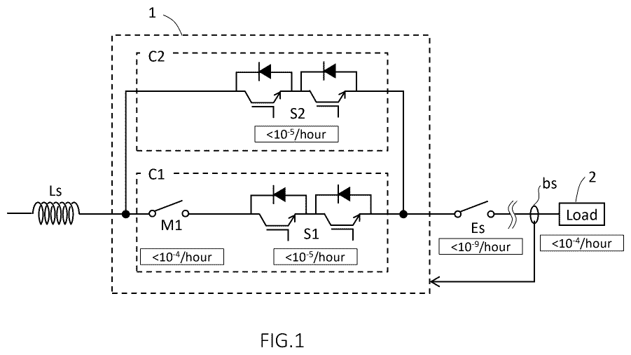

FIG. 1 shows an exemplary configuration of a circuit breaker according to Embodiment 1 of the present invention. The circuit breaker, 1, is connected to a load 2. The circuit breaker 1 may be connected, for example, between a direct current power source and the load 2. When a fault occurs in the load, the circuit breaker 1 interrupts the overcurrent flowing into the load. By way of example, the circuit breaker 1 is a DC circuit breaker.

The circuit breaker 1 shown in FIG. 1 includes a first circuit C1 and a second circuit C2. The first and second circuits C1 and C2 are connected in parallel. The first circuit C1 includes a first bidirectional semiconductor switch S1 and a first mechanical switch M1 connected in series therewith. The second circuit C2 includes a second bidirectional semiconductor switch S2.

In the implementation of FIG. 1, an inductor Ls and an electrical switch Es are provided on lines to which the circuit breaker 1 is connected, and are connected in series with the circuit breaker 1. The inductor Ls is a current-limiting inductor for reducing the rate of rise of overcurrent. The electrical switch Es is a switch for separating the load after completion of interruption by the circuit breaker 1 and thus ensuring insulation. It will be understood that the inductor Ls and electrical switch Es may be located upstream of the circuit breaker 1 (i.e., closer to the power source; primary) or downstream (i.e., closer to the load; secondary)

In the implementation shown in FIG. 1, each of the first and second bidirectional semiconductor switches S1 and S2 has a semiconductor switch element. Each semiconductor switch element includes two semiconductor transistors connected in series. In this implementation, the sources of the two semiconductor transistors are connected. Each of the two semiconductor transistors has a diode connected in parallel therewith for preventing reverse flow. The voltage across the gates of the two semiconductor transistors may be controlled to control the associated one of the first and second bidirectional semiconductor switches S1 and S2 between on and off. Each semiconductor transistor may be an IGBT, IGCT or MOS-FET, for example. Further, the semiconductor used for the semiconductor transistors may be Si or SiC, for example.

The first mechanical switch M1 switches between a closed state (i.e. “on”) and an open state (i.e. “off”) by mechanically switching its contact points between contact and separation. The first mechanical switch M1 may be a high-speed disconnector, for example. The mechanism of the mechanical switch may include, for example, a movable contact point, a fixed contact point and an actuating mechanism that moves the movable contact point into contact with and separation from the fixed contact point. The actuating mechanism used may be a high-speed switching mechanism such as Thomson drive, for example.

Each of the first and second bidirectional semiconductor switches S1 and S2 is controlled between on and off, i.e., conductive and interrupted, depending on the current detected by a sensor bs (i.e., current sensor) provided on the power supply path to the load. The current detected by the sensor bs is the load current, and also the current flowing through the circuit breaker 1. The first and second bidirectional semiconductor switches S1 and S2 may be controlled between on and off depending on other factors than load current, such as the state of the components of the circuit breaker 1. The first mechanical switch M1 is also controlled between on and off depending on the current detected by the sensor bs. Alternatively, the first mechanical switch M1 may be controlled between on and off depending on other factors than load current, such as the state of the components of the circuit breaker 1. Although not shown, the circuit breaker 1 may include a controller that controls the first and second bidirectional semiconductor switches S1 and S2 and first mechanical switch M1. The controller may be constituted by a circuit, for example.

During normal operation, the first bidirectional semiconductor switch S1 and the first mechanical switch M1 are on. Thus, the normal current flows through the first circuit C1, i.e., the first bidirectional semiconductor switch S1 and first mechanical switch M1. As used herein, “during normal operation” refers to a time for which the load is being supplied with current and is operating normally. The current supplied to the load, i.e., the current flowing through the circuit breaker 1 during normal operation will be referred to as normal current. During normal operation, the second bidirectional semiconductor switch S2 may be off.

When a fault in the load 2 is detected, the first bidirectional semiconductor switch S1 is turned off. This interrupts an overcurrent to the load. For example, a fault in the load 2 is detected based on the load current detected by the sensor bs. For example, the load 2 is determined to have a fault if at least one of the load current or its rate of change satisfies a condition for an overcurrent. This determination may be performed by a circuit incorporated in the circuit breaker 1, or may be performed by a circuit external to the circuit breaker 1. At the time of a fault in the load 2, the overcurrent is interrupted by a semiconductor switch, which reduces the interruption time compared with interruption with a mechanical switch, for example. For example, the interruption time for an overcurrent may be approximately 100 microseconds. This enables reducing the size and weight of the inductor Ls for reducing the rate of rise of overcurrent. It will be understood that, when a fault in the load 2 is detected, the first bidirectional semiconductor switch S1 may be turned off and then, after the current has dropped to zero, the first mechanical switch M1 may be turned off.

When a fault occurs in the first bidirectional semiconductor switch S1, the first mechanical switch M1 is opened to pass the normal current for the load 2 through the second circuit. This will avoid the circuit breaker 1 being unable to interrupt the overcurrent even when a fault has occurred in the first bidirectional semiconductor switch S1.

The circuit breaker 1 shown in FIG. 1 enables reducing the fault rate for the interrupting function while reducing the weight. An example thereof will be given below. By way of example, as shown in FIG. 1, the fault rate of the load 2 and the fault rate of the first mechanical switch M1 are set to below 10\hat{ }-4/hour and the fault rates of the first and second bidirectional semiconductor switches S1 and S2 are set to below 10\hat{ }-5/hour. In such implementations, the fault rate, as represented by the rate of simultaneous faults, of the first bidirectional semiconductor switch S1 and load 2 is lower than 10\hat{ }-9/hour. Similarly, the fault rate, as represented by the rate of simultaneous faults, of the second bidirectional semiconductor switch S2 and load 2 is also lower than 10\hat{ }-9/hour. The fault rate does not satisfy “lower than 10\hat{ }-9/hour” in the case of simultaneous faults in the first mechanical switch M1 and load 2, in the case of a fault in the first mechanical switch M1 alone, and in the case of a fault in one of the first and second bidirectional semiconductor switches S1 and S2 alone. In all these cases, the fail-safe operation by the circuit breaker 1 as discussed below will avoid the circuit breaker 1 being unable to interrupt the fault current.

In the case of simultaneous faults in the first mechanical switch M1 and load 2, the first bidirectional semiconductor switch S1 is turned off. This interrupts the overcurrent to the load.

In the case of a fault in the first mechanical switch M1 alone, the first bidirectional semiconductor switch S1 is turned off to block the normal current. For example, when the mechanical switch breaks while being open, or when the conduction voltage is higher than an expected conduction voltage, it is determined that the mechanical switch has a fault. The first bidirectional semiconductor switch S1 is configured to turn off when a fault in the first mechanical switch M1 has been detected.

In the case of a fault in the first bidirectional semiconductor switch S1, the first mechanical switch M1 is turned off and the second bidirectional semiconductor switch S2 is turned on to commutate the normal current to the second circuit C2. Thereafter, normal operation may be continued as before. Alternatively, after insulation by the first mechanical switch M1 has been established, the second bidirectional semiconductor switch S2 may be turned off to block the normal current. In this case, during commutation, no voltage for generating an arc is applied to the first mechanical switch M1. Thus, the size and weight of the first mechanical switch M1 may be reduced compared with an arrangement where an overcurrent is expected.

In the case of a fault in the second bidirectional semiconductor switch S2 alone, the operation of the load 2 is stopped. A bidirectional semiconductor switch is determined to have a fault when the bidirectional semiconductor switch breaks while being open or when the conduction voltage is higher than an expected conduction voltage, for example. When a fault in the second bidirectional semiconductor switch S2 has been detected, with the second bidirectional semiconductor switch S2 remaining on, the first bidirectional semiconductor switch S1 is turned off.

The settings of the fault rates of the various parts and the fail-safe function discussed above will ensure that the fault rate, as represented by the rate of a fault that makes it impossible for the circuit breaker 1 to interrupt a fault current (i.e., the fault rate for the interrupting function), is lower than 10\hat{ }-9/hour. It will be understood that the fault rate of the electrical switch Es can be kept lower than 10\hat{ }-9/hour by providing a plurality of series of electrical switches Es, for example. Further, the first and second bidirectional semiconductor switches S1 and S2 used may be ones of which the nominal value of the fault rate is lower than 10\hat{ }-5/hour. Alternatively, the first and second bidirectional semiconductor switches S1 and S2 may be semiconductor switches of which the nominal value of the fault rate is not lower than 10\hat{ }-5/hour and an self-diagnosis function may be added to provide an arrangement where the fault rates of the first and second bidirectional semiconductor switches S1 and S2 can essentially be considered to be lower than 10\hat{ }-5/hour (see Embodiment 4).

### Embodiment 2

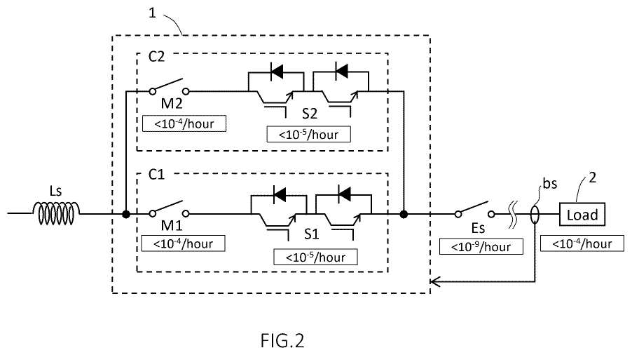

FIG. 2 shows an exemplary configuration of a circuit breaker according to Embodiment 2. The circuit breaker 1 shown in FIG. 2 is different from the circuit breaker 1 of FIG. 1 in that the second circuit includes a second mechanical switch M2. The second mechanical switch M2 is connected in series with the second bidirectional semiconductor switch S2. The second mechanical switch M2 may be a mechanical switch with the same configuration as the first mechanical switch M1.

In the circuit breaker 1 of FIG. 2, during normal operation, the first and second bidirectional semiconductor switches S1 and S2 and the first and second mechanical switches M1 and M2 are on. The normal current flows in parallel through the first and second circuits C1 and C2. Since the normal current is distributed among the first and second circuits C1 and C2, conduction losses during normal operation will be reduced.

When a fault in the load 2 is detected, the first and second bidirectional semiconductor switches S1 and S2 are turned off. This interrupts the overcurrent due to the fault in the load 2. Thus, since an overcurrent is interrupted by a semiconductor switch, this will reduce the interruption time. For example, the interruption time may be approximately 100 microseconds. This enables reducing the size and weight of the current-limiting inductor Ls. It will be understood that, when a fault in the load 2 has been detected, the first and second bidirectional semiconductor switches S1 and S2 may be turned off and, then, after the current drops to zero, the first and second mechanical switches M1 and M2 may be turned off.

In the case of a fault in the first bidirectional semiconductor switch S1, the first mechanical switch M1 is opened to pass the normal current for the load 2 through the second circuit C2. In the case of a fault in the second bidirectional semiconductor switch S2, the second mechanical switch M2 is opened to pass the normal current for the load 2 through the first circuit C1. This will avoid the circuit breaker 1 being unable to interrupt the overcurrent in the case of a fault in either the first bidirectional semiconductor switch S1 or the second bidirectional semiconductor switch S2.

The circuit breaker 1 shown in FIG. 2 enables reducing the fault rate for the interrupting function while reducing weight. By way of example, as shown in FIG. 2, the fault rate of the load 2 and the fault rate of the first mechanical switch M1 are set to below 10\hat{ }-4/hour and the fault rates of the first and second bidirectional semiconductor switches S1 and S2 are set to below 10\hat{ }-5/hour. In this case, the fault rate as represented by the rate of simultaneous faults in the first bidirectional semiconductor switch S1 and load 2, the fault rate as represented by the rate of simultaneous faults in the second bidirectional semiconductor switch S2 and load 2, and the fault rate as represented by the rate of simultaneous faults in the first and second bidirectional semiconductor switches S1 and S2 are all lower than 10\hat{ }-9/hour. The fault rate does not satisfy “lower than 10\hat{ }-9/hour” in the case of simultaneous faults in the first mechanical switch M1 and load 2, in the case of a fault in one of the first and second mechanical switches M1 and M2 alone, and in the case of a fault in one of the first and second bidirectional semiconductor switches S1 and S2 alone. In all these cases, the fail-safe operation by the circuit breaker 1 as discussed below will avoid the circuit breaker 1 being unable to interrupt the fault current.

In the case of simultaneous faults in the first mechanical switch M1 and load 2, the first and second bidirectional semiconductor switches S1 and S2 are turned off. This interrupts the overcurrent to the load 2. When a fault in the first mechanical switch M1 has been detected and a fault in the load 2 has been detected, the first and second bidirectional semiconductor switches S1 and S2 are turned off.

In the case of a fault in the first mechanical switch M1 alone, the first bidirectional semiconductor switch S1 is turned off to commutate the normal current is commutated to the second circuit C2. Thereafter, normal operation may be continued. Alternatively, the second bidirectional semiconductor switch S2 is turned off to block the normal current. In the case of a fault in the second mechanical switch M2 alone, the second bidirectional semiconductor switch S2 may be turned off to commutate the normal current to the first circuit C1. Thereafter, normal operation may be continued. Alternatively, the first bidirectional semiconductor switch S1 may be turned off to block the normal current.

In the case of simultaneous faults in the first and second mechanical switches M1 and M2, the first and second bidirectional semiconductor switches S1 and S2 are turned off to block the normal current. In other words, when a fault in the first mechanical switch M1 has been detected and a fault in the second mechanical switch M2 has been detected, the first and second bidirectional semiconductor switches S1 and S2 are turned off. For example, when a fault in the first mechanical switch M1 has been detected and, with the first bidirectional semiconductor switch S1 having been turned off to pass the normal current through the second circuit C2, a fault in the second mechanical switch M2 has detected, then, the second bidirectional semiconductor switch S2 is also turned off to block the normal current.

In the case of a fault in the first bidirectional semiconductor switch S1 alone, the first mechanical switch M1 is turned off to commutate the normal current to the second circuit C2. Thereafter, normal operation may be continued. Alternatively, in addition to the first mechanical switch M1, at least one of the second bidirectional semiconductor switch S2 or the second mechanical switch M2 may be turned off to block the normal current. When the first mechanical switch M1 is turned off to commutate the normal current to the circuit C2, no voltage for generating an arc is applied to the first mechanical switch M1. This enables reducing the size and weight of the first mechanical switch M1 compared with an arrangement where an overcurrent is expected.

In the case of a fault in the second bidirectional semiconductor switch S2 alone, the second mechanical switch M2 is turned off to commutate the normal current to the first circuit C1. Thereafter, normal operation may be continued. Alternatively, in addition to the second mechanical switch M2, at least one of the first bidirectional semiconductor switch S1 or the first mechanical switch M1 may be turned off to block the normal current. When the second mechanical switch M2 is turned off to commutate the normal current to the first circuit C1, no voltage for generating an arc is applied to the second mechanical switch M2. This enables reducing the size and weight of the second mechanical switch M2 compared with an arrangement where an overcurrent is expected.

The settings of the fault rates of the various parts and the fail-safe function discussed above will ensure that the fault rate, as represented by the rate of a fault that makes it impossible for the circuit breaker 1 to interrupt a fault current (i.e., the fault rate for the interrupting function), is lower than 10\hat{ }-9/hour.

### Embodiment 3

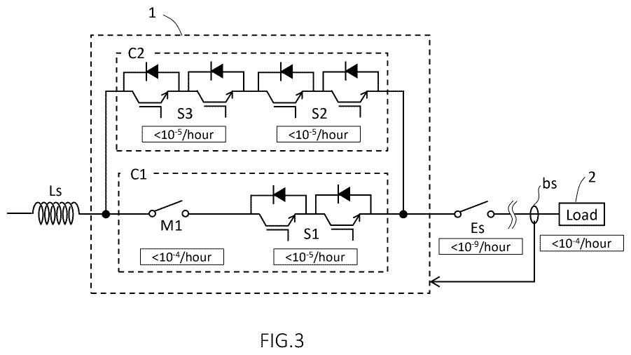

FIG. 3 shows an exemplary configuration of a circuit breaker according to Embodiment 3. The circuit breaker 1 shown in FIG. 3 is different from the circuit breaker 1 of FIG. 2 in that the second circuit includes a third bidirectional semiconductor switch S3 in lieu of the second mechanical switch M2. The third bidirectional semiconductor switch S3 is connected in series with the second bidirectional semiconductor switch S2. The third bidirectional semiconductor switch S3 may be a bidirectional semiconductor switch with the same configuration as the first or second bidirectional semiconductor switches S1 or S2.

In the circuit breaker of FIG. 3, during normal operation, the first, second and third bidirectional semiconductor switches S1, S2 and S3 as well as the first mechanical switch M1 are on. The normal current flows in parallel through the first and second circuits C1 and C2. Since the normal current is distributed among the first and second circuits C1 and C2, conduction losses during normal operation will be reduced.

When a fault in the load 2 is detected, the first, second and third bidirectional semiconductor switches S1, S2 and S3 are turned off. This interrupts the overcurrent due to the fault in the load 2. Thus, since an overcurrent is interrupted by a semiconductor switch, this reduces the interruption time. For example, the interruption time may be approximately 100 microseconds. This enables reducing the size and weight of the current-limiting inductor Ls.

In the case of a fault in the first bidirectional semiconductor switch S1, the first mechanical switch M1 is opened to pass the normal current for the load 2 through the second circuit C2. In the case of a fault in one of the second bidirectional semiconductor switch S2 or third bidirectional semiconductor switch S3, that one of the second bidirectional semiconductor switch S2 or third bidirectional semiconductor switch S3 which has no fault is opened to pass the normal current for the load 2 through the first circuit C1. This will avoid the circuit breaker 1 being unable to interrupt the overcurrent even with a fault in one of the first, second or third bidirectional semiconductor Switch S1, S2 or S3.

The circuit breaker 1 shown in FIG. 3 enables reducing the fault rate for the interrupting function while reducing weight. By way of example, as shown in FIG. 3, the fault rate of the load 2 and the fault rate of the first mechanical switch M1 are set to below 10\hat{ }-4/hour and the fault rates of the first, second and third bidirectional semiconductor switches S1, S2 and S3 are set to below 10\hat{ }-5/hour. In this case, the fault rates as represented by the rates of simultaneous faults in S1 and load 2, simultaneous faults in S2 and load 2, simultaneous faults in S3 and load 2, simultaneous faults in S1 and S2, simultaneous faults in S2 and S3, and simultaneous faults in S1 and S3 are all lower than 10\hat{ }-9/hour. The fault rate does not satisfy “lower than 10\hat{ }-9/hour” in the cases of simultaneous faults in the first mechanical switch M1 and load 2, a fault in the first mechanical switch M1 alone, and a fault in one of the first, second and third bidirectional semiconductor switches S1, S2 and S3 alone. In all these cases, the fail-safe operation by the circuit breaker 1 discussed below will avoid the circuit breaker 1 being unable to interrupt the fault current.

In the case of simultaneous faults in the first mechanical switch M1 and load 2, the first, second and third bidirectional semiconductor switches S1, S2 and S3 are turned off. This interrupts the overcurrent in the load 2. When a fault in the first mechanical switch M1 is detected and a fault in the load 2 is detected, the first, second and third bidirectional semiconductor switches S1, S2 and S3 are turned off.

In the case of a fault in the first mechanical switch M1 alone, the first bidirectional semiconductor switch S1 is turned off to commutate the normal current to the second circuit C2. Thereafter, normal operation may be continued. Alternatively, the second and third bidirectional semiconductor switches S2 and S3 may be turned off to block the normal current.

In the case of a fault in the first bidirectional semiconductor switch S1 alone, the first mechanical switch M1 is turned off to commutate the normal current to the second circuit C2. Thereafter, normal operation may be continued. Alternatively, in addition to the first mechanical switch M1, at least one of the second or third bidirectional semiconductor switch S2 or S3 may be turned off to block the normal current. When the first mechanical switch M1 is turned off to commutate the normal current to the second circuit C2, no voltage for generating an arc is applied to the first mechanical switch M1. This enables reducing the size and weight of the first mechanical switch M1 compared with an arrangement where an overcurrent is expected.

In the case of a fault in the second bidirectional semiconductor switch S2 alone, the third bidirectional semiconductor switch S3 is turned off to commutate the normal current to the first circuit C1. Thereafter, normal operation may be continued. Alternatively, in addition to the third bidirectional semiconductor switch S3, at least one of the first bidirectional semiconductor switch S1 or first mechanical switch M1 may be turned off to block the normal current.

In the case of a fault in the third bidirectional semiconductor switch S3 alone, the second bidirectional semiconductor switch S2 is turned off to commutate the normal current to the first circuit C1. Thereafter, normal operation may be continued. Alternatively, in addition to the second bidirectional semiconductor switch S2, at least one of the first bidirectional semiconductor switch S1 or first mechanical switch M1 may be turned off to block the normal current.

The settings of the fault rates of the various parts and the fail-safe function discussed above will ensure that the fault rate, as represented by the rate of a fault that makes it impossible for the circuit breaker 1 to interrupt a fault current (i.e., the fault rate for the interrupting function), is lower than 10\hat{ }-9/hour.

### Embodiment 4

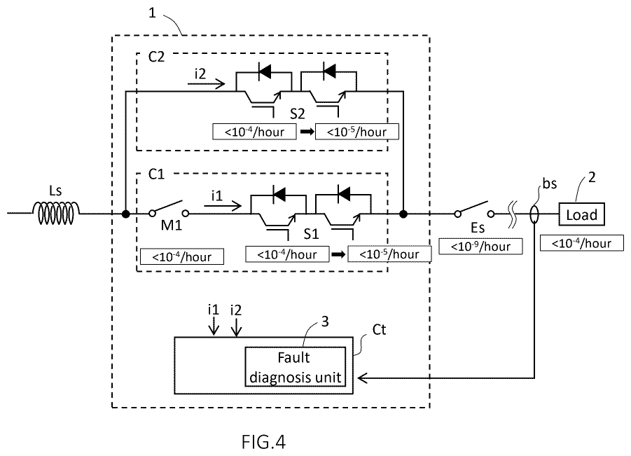

FIG. 4 shows an exemplary configuration of a circuit breaker according to Embodiment 4. The circuit breaker 1 shown in FIG. 4 is different from the circuit breaker 1 shown in FIG. 1 in that it further includes a fault diagnosis unit 3. In other words, the circuit breaker 1 of Embodiment 4 is the same as for Embodiment 1 except that a fault diagnosis function has been added. The fault diagnosis unit 3 is part of a controller Ct that controls the first mechanical switch M1 and the first and second bidirectional semiconductor switches between on and off. The fault diagnosis unit 3 regularly performs a fault diagnosis process for the first and second bidirectional semiconductor switches S1 and S2.

The fault diagnosis unit 3 is capable of determining whether there is a fault in a bidirectional semiconductor switch based on current i1 in the first circuit C1 and current i2 in the second circuit C2. By way of example, during normal operation, the fault diagnosis unit 3 is capable of determining whether there is a fault in the first and second bidirectional semiconductor switches S1 and S2 using current i2 in the second circuit C2 flowing when S1 is on and S2 is off and current i1 in the first circuit C1 flowing when S1 is off and S2 is on. In such implementations, the circuit breaker 1 may include a sensor for detecting current i1 in the first circuit C1 and a sensor for detecting current i2 in the second circuit C2.

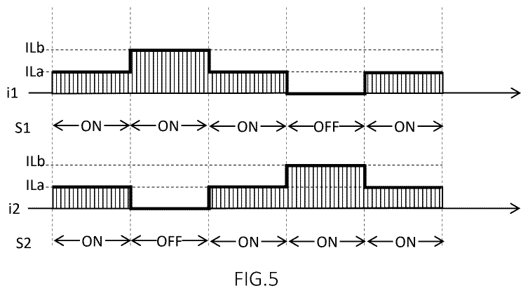

FIG. 5 illustrates an exemplary fault diagnosis process by the circuit breaker 1 shown in FIG. 4. FIG. 5 shows changes over time in current i1 in the first circuit C1, current i2 in the second circuit C2, the on/off state of the first bidirectional semiconductor switch S1, and the on/off state of the second bidirectional semiconductor switch S2. In the implementation shown in FIG. 5, while the normal current is flowing, the fault diagnosis unit 3 controls the first and second bidirectional semiconductor switches S1 and S2 between on and off to create a period in which one of S1 and S2 is off and the other one is on. During such a period, the fault diagnosis unit 3 is capable of determining whether there is a fault in S1 and S2 based on current i1 in the first circuit C1 and current i2 in the second circuit C2 that have been detected. During such a period, all the normal current flows through the one of the circuits where the bidirectional semiconductor switch is on, and the normal current is interrupted in the circuit where the switch is off. If this set of events is detected, the fault diagnosis unit 3 determines that there is no fault.

For example, as shown in FIG. 5, during normal operation and when both S1 and S2 are on, the levels of currents i1 and i2 are both at ILa. From this state, when S1 is turned off, all the normal current flows into the second circuit C2 such that the level of current i2 rises to ILb (ILa<ILb) and the level of current i1 drops to zero. Further, during normal operation and when both S1 and S2 are on and then S2 is turned off, the level of current i1 rises to ILb and the level of current i2 drops to zero. The fault diagnosis unit 3 determines changes in currents i1 and i2 caused by S1 or S2 switching between on and off to determine whether there is a fault in S1 and S2. For example, when S1 being on is turned off and if the level of current i1 being ILa drops to zero, the fault diagnosis unit 3 determines that the turn-off function of S1 is normal. If the level of current i1 remains ILa and does not drops to zero, the fault diagnosis unit 3 determines that the turn-off function of S1 has a fault. When S1 being off is turned on and if the level of current i1 returns from zero to ILa, the unit determines that the turn-on function of S1 is normal. If the level of current i1 remains at zero and does not return to ILa, the unit determines that the turn-on function of S1 has a fault. The unit is capable of determining whether there is a fault in S2 in an analogous manner.

Thus, the fault diagnosis unit 3 controls the first bidirectional semiconductor switch S1 and the second bidirectional semiconductor switch S2 between on and off and thus, during normal operation, alternately and temporarily commutate the normal current to the first and second circuits C1 and C2, and detects at least one of current i1 in the first circuit C1 or current i2 in the second circuit C2 during commutation. Based on the current detected, the fault diagnosis unit 3 determines whether or not there is a fault in the first bidirectional semiconductor switch S1 or second bidirectional semiconductor switch S2.

When the fault diagnosis unit 3 detects a fault in the first bidirectional semiconductor switch S1 or second bidirectional semiconductor switch S2, the circuit breaker 1 performs a fail-safe operation in the same manner as in Embodiment 1 above.

For example, if the fault diagnosis process by the first bidirectional semiconductor switch S1 is repeated K1 times per hour, the fault rate of the first bidirectional semiconductor switch S1 can essentially be considered to decrease to 1/K1. For example, if the fault diagnosis process by the first bidirectional semiconductor switch S1 is repeated K1 times per hour (where K1=10), the time from the occurrence of a fault in the first bidirectional semiconductor switch S1 until, after identification of the fault, the path is interrupted is 1/10 of an hour. In other words, the time for which an element with no fault resides together with the first bidirectional semiconductor switch S1 which has a fault is reduced to 1/10 of an hour. Thus, the fault rate of the first bidirectional semiconductor switch S1 can essentially be considered to have decreased to 1/10. For example, if the nominal value of the fault rate of the first bidirectional semiconductor switch S1 is lower than 10\hat{ }-4/hour, performing the fault diagnosis process by the first bidirectional semiconductor switch S1 10 times per hour (K1=10) will make it possible to consider the fault rate of the first bidirectional semiconductor switch S1 to be 10\hat{ }-5/hour.

Similarly, as the fault diagnosis process by the second bidirectional semiconductor switch S2 is repeated K2 times per hour, the fault rate of the second bidirectional semiconductor switch S1 can essentially be considered to decrease to 1/K2.

Considering all this, the fault rate of the load 2, the nominal value of the fault rate of the first bidirectional semiconductor switch S1, and the number of times the fault diagnosis is performed by the first bidirectional semiconductor switch S1 per hour, K1, can be set to such values that the product of the fault rate of the load 2, the nominal value of the fault rate of the first bidirectional semiconductor switch S1 and 1/K1 is less than 10\hat{ }-9/hour. This will facilitate reducing the fault rate of the circuit breaker 1.

Analogously, the fault rate of the load 2, the nominal value of the fault rate of the second bidirectional semiconductor switch S2, and the number of times the fault diagnosis is performed by the second bidirectional semiconductor switch S2 per hour, K2, can be set to such values that the product of the fault rate of the load 2, the nominal value of the fault rate of the first bidirectional semiconductor switch and 1/K2 is less than 10\hat{ }-9/hour. This will further facilitate reducing the fault rate for the interrupting function of the circuit breaker 1.

Although K1 and K2 are not limited to any particular values, the fault diagnosis unit 3 may perform the fault diagnosis process at least once per hour for each of the first and second bidirectional semiconductor switches S1 and S2, for example.

The fault diagnosis unit 3 may perform the fault diagnosis for each of the first and second bidirectional semiconductor switches S1 and S2 in a constant cycle, for example. This will enable performing the fault diagnosis process efficiently. It will be understood that the cycle of the fault diagnosis process for each of the first and second bidirectional semiconductor switches S1 and S2 may not be exactly constant. For example, the fault diagnosis process may be performed at time points within one hour that are uniformly distributed and dispersed to some degree. Thus, implementations where the fault diagnosis process is regularly performed include implementations where the fault diagnosis process is performed in a constant cycle or at time points dispersed to such a degree as to contribute to a decrease in fault rate.

In the present implementation, the fault diagnosis unit 3 successively performs an operation where both S1 and S2 are on to pass the normal current through the first and second circuits C1 and C2, a first circuit commutation operation where S1 is on and S2 is off to pass the normal current through the first circuit C1, and a second circuit commutation operation where S1 is off and S2 is on to pass the normal current through the second circuit C2. Based on current i2 in the second circuit C2 detected during the first circuit commutation operation, the fault diagnosis unit 3 determines whether there is a fault in the second bidirectional semiconductor switch S2, and, based on current i1 in the first circuit C1 detected during the second circuit commutation operation, determines whether there is a fault in the first bidirectional semiconductor switch S1. This determination process is regularly and repeatedly performed. This will enable performing the fault diagnosis process efficiently. The order of the first and second circuit commutation operations is not limited to the one shown in FIG. 5. Further, the unit may determine whether there is a fault in S2 based on current i1 in the first circuit C1 detected during the first circuit commutation operation. Similarly, the unit may determine whether there is a fault in S1 based on current i2 in the second circuit C2 detected during the second circuit commutation operation.

Each of the lengths of the periods of the first and second circuit commutation operations are preferably shorter than the period for which both S1 and S2 are on to pass the normal current in parallel. This will increase the reduction in loss achieved by the normal current flowing in parallel.

A fault diagnosis unit 3 may also be added to the circuit breaker 1 according to Embodiment 2 above. A fault diagnosis unit 3 with the same configuration and operation as the fault diagnosis unit 3 described above may be added to the circuit breaker 1 according to Embodiment 2. In such implementations, for example, in the arrangement shown in FIG. 2, the fault rate of the load 2, the nominal values of the fault rates of the first and second bidirectional semiconductor switches S1 and S2, and the numbers of times the fault diagnosis is performed for the first and second bidirectional semiconductor switches S1 and S2 per hour, K1 and K2, may be set to such values that the nominal values of the fault rates of the first and second bidirectional semiconductor switches S1 and S2 multiplied by 1/K1 and 1/K2 are less than 10\hat{ }-9/hour.

### Embodiment 5

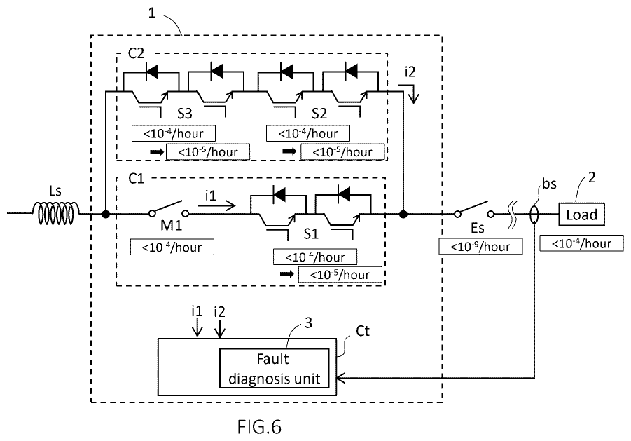

FIG. 6 shows an exemplary configuration of a circuit breaker according to Embodiment 5. The circuit breaker 1 shown in FIG. 6 is different from the circuit breaker 1 shown in FIG. 3 in that it further includes a fault diagnosis unit 3. In other words, the circuit breaker 1 of Embodiment 5 is the same as for Embodiment 3 except that the function of fault diagnosis has been added. The fault diagnosis unit 3 is part of a controller Ct that controls the first mechanical switch M1 and the first, second and third bidirectional semiconductor switches S1, S2 and S3 between on and off. The fault diagnosis unit 3 regularly performs the fault diagnosis process for the first, second and third bidirectional semiconductor switches S1, S2 and S3.

During normal operation, the fault diagnosis unit 3 determines whether there is a fault in the first bidirectional semiconductor switch S1, second bidirectional semiconductor switch S2 and third bidirectional semiconductor switch S3 using current i1 in the first circuit C1 flowing when S1 is off and S2 and S3 are on, current i2 in the second circuit C2 flowing when S1 and S3 are on and S2 is off, and current i2 in the second circuit C2 flowing when S1 and S2 are on and S3 is off. In such implementations, the circuit breaker 1 may include a sensor for detecting current i1 in the first circuit C1 and a sensor for detecting current i2 in the second circuit C2.

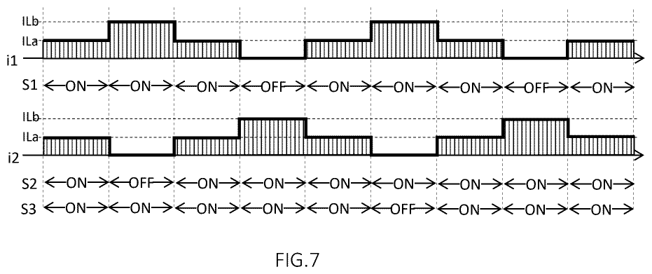

FIG. 7 illustrates an exemplary fault diagnosis process by the circuit breaker 1 shown in FIG. 6. FIG. 7 shows current i1 in the first circuit C1, current i2 in the second circuit C2, and the on/off states of the first, second and third bidirectional semiconductor switches S1, S2 and S3. In the implementation shown in FIG. 7, the fault diagnosis unit 3 controls the first, second and third bidirectional semiconductor switches S1, S2 and S3 between on and off while the normal current is flowing to create a period in which one of S1, S2 and S3 is off and the others are on. During such a period, the fault diagnosis unit 3 is capable of determining whether there is a fault in S1, S2 and S3 based on current i1 in the first circuit C1 and current i2 in the second circuit C2 that have been detected. During such a period, the normal current in the one of the circuit in which the bidirectional semiconductor switch(es) is/are off is interrupted, while all the normal current flows through the other circuit. When this set of events is detected, the fault diagnosis unit 3 determines that there is no fault.

For example, as shown in FIG. 7, during normal operation and when S1, S2 and S3 are all on, the levels of the currents i1 and i2 are both at ILa. From this state, when S1 is turned off, all the normal current flows through the second circuit C2 such that the level of current i2 rises to ILb (ILa<ILb) and the level of current i1 drops to zero. Further, during normal operation and when S1, S2 and S3 are all on and then one of S2 or S3 is turned off, the level of current i1 rises to ILb and the level of the current i2 drops to zero. The fault diagnosis unit 3 determines changes in currents i1 and i2 caused by S1, S2 and S3 being switched on and off to determine whether there is a fault in S1 and S2. For example, when S2 being on is turned off and the level of current i2 being ILa drops to zero, the fault diagnosis unit 3 determines that the turn-off function of S2 is normal. If the level of current i2 remains ILa and does not drops to zero, the fault diagnosis unit 3 determines that the turn-off function of S2 has a fault. If S2 being off is turned on and the level of current i2 returns from zero to ILa, the unit determines that the turn-on function of S2 is normal. If the level of current i2 remains at zero and does not return to ILa, the unit determines that the turn-on function of S2 has a fault. The unit is capable of determining whether there is a fault in S1 and S3 in an analogous manner.

Thus, the fault diagnosis unit 3 controls the first, second and third bidirectional semiconductor switches S1, S2 and S3 between on and off and thus, during normal operation, alternately and temporarily commutate the normal current to the first and second circuits C1 and C2, and detects at least one of current i1 in the first circuit C1 or current i2 in the second circuit C2 during commutation. Based on the current detected, the fault diagnosis unit 3 determines whether there is a fault in the first, second and third bidirectional semiconductor switch S1, S2 and S3.

When the fault diagnosis unit 3 detects a fault in the first bidirectional semiconductor switch S1, second bidirectional semiconductor switch S2 or third bidirectional semiconductor switch S3, the circuit breaker 1 performs a fail-safe operation in the same manner as in Embodiment 3 above.

For example, as the fault diagnosis process by the third bidirectional semiconductor switch S3 is repeated K3 times per hour, the fault rate of the third bidirectional semiconductor switch S3 can essentially be considered to decrease to 1/K3. The same applies to the first bidirectional semiconductor switches S1 and S2.

This makes it possible to set the fault rate of the load 2, the nominal value of the fault rate of the third bidirectional semiconductor switch S3, and the number of times the fault diagnosis is performed by the third bidirectional semiconductor switch S3 per hour, K3, to such values that the product of the fault rate of the load 2, the nominal value of the fault rate of the third bidirectional semiconductor switch S3 and 1/K3 is less than 10\hat{ }-9/hour. This will facilitate reducing the fault rate for the interrupting function of the circuit breaker 1. It will be understood that the fault rate of the load 2, the nominal values of the fault rates of the first and second bidirectional semiconductor switches S1 and S2 and the numbers of times the fault diagnosis is performed by the first and second bidirectional semiconductor switches S1 and S2 per hour, K1 and K2, can be set to such values that the product of the fault rate of the load 2, the nominal value of the fault rate of the first bidirectional semiconductor switch S1 and 1/K1, as well as the product of the fault rate of the load 2, the nominal value of the fault rate of the second bidirectional semiconductor switch S2 and 1/K2 are less than 10\hat{ }-9/hour.

Although K1, K2 and K3 are not limited to any particular values, the fault diagnosis unit 3 may perform the fault diagnosis process at least once per hour for each of the first, second and third bidirectional semiconductor switches S1, S2 and S3, for example (1≤K1, 1≤K2, 1≤K3).

The fault diagnosis unit 3 may perform the fault diagnosis for each of the first, second and third bidirectional semiconductor switches S1, S2 and S3 in a constant cycle, for example. This will enable performing the fault diagnosis process efficiently. It will be understood that the cycle of the fault diagnosis process for each of the first, second and third bidirectional semiconductor switches S1, S2 and S3 may not be exactly constant.

In the present implementation, in connection with the fault diagnosis unit 3, an operation where all of S1, S2 and S3 are on to pass the normal current in parallel through the first and second circuits C1 and C2, a first S2-off circuit commutation operation where S1 and S3 are on and S2 is off to pass the normal current through the first circuit C1, a first S3-off circuit commutation operation for turning S1 and S2 on and turning S3 off to pass the normal current through the first circuit C1, and a second circuit commutation operation where S1 is off and S2 and S3 are on to pass the normal current through the second circuit C2 are successively performed. Based on current i2 in the second circuit C2 detected during the first S2-off circuit commutation operation, the fault diagnosis unit 3 determines whether there is a fault in the second bidirectional semiconductor switch S2. Based on current i2 in the second circuit C2 detected during the first S3-off circuit commutation operation, the fault diagnosis unit 3 determines whether there is a fault in the third bidirectional semiconductor switch S3. Further, based on current i1 in the first circuit C1 detected during the second circuit commutation operation, the fault diagnosis unit 3 determines whether there is a fault in the first bidirectional semiconductor switch S1. These determination processes are regularly and repeatedly performed. This will enable performing the fault diagnosis process efficiently. The order of the first S2-off circuit commutation operation, the first S3-off circuit commutation operation and the second circuit commutation operation is not limited to the one shown in FIG. 7.

Each of the lengths of the periods of the first S2-off circuit commutation operation, the first S3-off circuit commutation operation and the second circuit commutation operation are preferably shorter than the period for which all of S1, S2 and S3 are on to pass the normal current in parallel. This will increase the reduction in loss achieved by the normal current flowing in parallel.

The circuit breaker according to the present invention is not limited to the above-described embodiments. For example, the circuit breaker may include further elements in addition to the above-described components. For example, the first and second bidirectional semiconductor switches S1 and S2 may have energy absorption circuits connected in parallel thereto. An energy absorption circuit may include a capacitor or a voltage clamping element, for example. A voltage clamping element is constituted by a voltage clamping circuit using a varistor, Zener diode, or other semiconductors, for example.

Further, in the first circuit, in addition to the first bidirectional semiconductor switch, one or more other bidirectional semiconductor switches may be connected in series. Similarly, in the second circuit, one or more additional bidirectional semiconductor switches connected in series may be provided.

Implementations where a circuit breaker is designed such that the product of the fault rate of the load and the fault rate of the first bidirectional semiconductor switch as well as the product of the fault rate of the load and the fault rate of the second bidirectional semiconductor switch are less than 10\hat{ }-9/hour are not limited to the above-described embodiments. For example, since a load includes semiconductors, for example, its fault rate is generally set to below 10\hat{ }-4/hour. In such implementations, to ensure that the probability of faults in the bidirectional semiconductor switches S1, S2 and S3 and the load occurring simultaneously is lower than 10\hat{ }-9/hour, the fault rates of the bidirectional semiconductor switches S1, S2 and S3 must be lower than 10\hat{ }-5/hour. If the nominal values of the fault rates of the bidirectional semiconductor switches S1, S2 and S3 are 10\hat{ }-4/hour, a circuit breaker may be designed to include a fault diagnosis unit, as in Embodiments 4 and 5 above, such that the fault rates of the bidirectional semiconductor switches S1, S2 and S3 are essentially lower than 10\hat{ }-5/hour. In a variation thereof, the circuit breaker may use no fault diagnosis and be designed such that the fault rates of the bidirectional semiconductor switches S1, S2 and S3 are lower than 10\hat{ }-5/hour.

For example, a fault in the bidirectional semiconductor switches S1, S2 and S3 may be caused either by (1) deterioration of semiconductors themselves, or (2) a defect in the signaling system including the drive circuit. In the latter case, (2), a double system may be constructed using an electronic circuit, for example, to reduce the fault rate of a single system to below 10\hat{ }-2.5/hour. In the former case, (1), deterioration of semiconductors is caused by heat generated by the regular current (i.e., normal current) creating a heat cycle and thus causing fatigue at various joints. As such, fatigue can be reduced by reducing temperature increase at various locations. For example, a circuit breaker may be designed so as to sufficiently reduce the ratio of the regular current (i.e., normal current) to the rated current. This will reduce the probability of a fault due to deterioration of semiconductors.

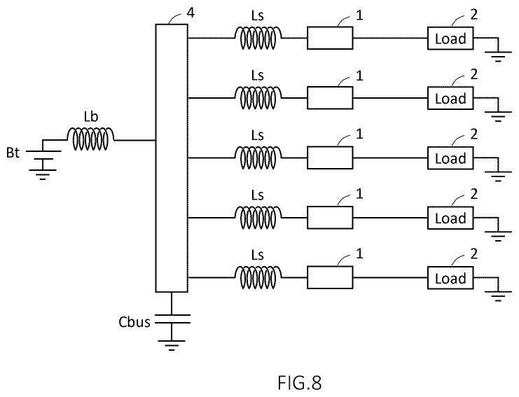

Further, embodiments of the present invention include a DC grid system including a circuit breaker according to any one of above-described embodiments. FIG. 8 shows an exemplary configuration of a DC grid system including circuit breakers. The DC grid system includes a bus 4 connected to a direct current power source Bt, a plurality of loads 2 connected in parallel to the bus 4, inductors Ls connected between the bus 4 and the respective loads 2, and circuit breakers 1. Each of the circuit breakers 1 may have the same configuration as the circuit breaker 1 of any one of the above-described embodiments. The circuit breakers 1 will enable reducing the fault rate for the interrupting function while reducing weight. This will significantly contribute to reducing the weight of the entire DC grid system and improving reliability.

### REFERENCE SIGNS LIST

1: circuit breaker
2: load
3: fault diagnosis unit
C1: first circuit
C2: second circuit
S1: first bidirectional semiconductor switch
S2: second bidirectional semiconductor switch
S3: third bidirectional semiconductor switch
M1: first mechanical switch
M2: second mechanical switch

1. A circuit breaker connected to a load, comprising:
a first circuit including a first bidirectional semiconductor switch; and
a second circuit connected in parallel with the first circuit and including a second bidirectional semiconductor switch,
wherein:
at least the first circuit out of the first circuit or the second circuit includes a first mechanical switch connected in series with the first bidirectional semiconductor switch;
during normal operation, the first bidirectional semiconductor switch and the first mechanical switch are turned on to pass a normal current through the first circuit;
when a fault occurs in the load, the first bidirectional semiconductor switch is turned off to interrupt an overcurrent; and,
when a fault occurs in the first bidirectional semiconductor switch, the first mechanical switch is opened to pass the normal current for the load through the second circuit.

2. The circuit breaker according to claim 1, wherein:
the second circuit does not include a mechanical switch connected in series with the second bidirectional semiconductor switch;
during normal operation, the first bidirectional semiconductor switch and the first mechanical switch are turned on and the second bidirectional semiconductor switch is turned off to pass the normal current through the first circuit;
when a fault occurs in the load, the first bidirectional semiconductor switch is turned off to block an overcurrent; and
when a fault occurs in the first bidirectional semiconductor switch, the first mechanical switch is opened to pass the normal current for the load through the second circuit, and, after insulation of the first mechanical switch recovers, the second bidirectional semiconductor switch is turned off.

3. The circuit breaker according to claim 1, wherein:
the first circuit includes the first mechanical switch connected in series with the first bidirectional semiconductor switch; and
the second circuit includes a second mechanical switch connected in series with the second bidirectional semiconductor switch.

4. The circuit breaker according to claim 3, wherein:
during normal operation, the first mechanical switch and the second mechanical switch are turned on and the first bidirectional semiconductor switch and the second bidirectional semiconductor switch are turned on to pass the normal current through the first circuit and the second circuit;
when a fault occurs in the load, the first bidirectional semiconductor switch and the second bidirectional semiconductor switch are turned off to block an overcurrent;
when a fault occurs in the first bidirectional semiconductor switch, the first mechanical switch is opened to pass the normal current for the load through the second circuit, and, thereafter, either normal operation is continued or, after insulation of the first mechanical switch recovers, the second bidirectional semiconductor switch is turned off; and,
when a fault occurs in the second bidirectional semiconductor switch, the second mechanical switch is opened to pass the normal current for the load through the first circuit, and, thereafter, either normal operation is continued or, after insulation of the second mechanical switch recovers, the first bidirectional semiconductor switch is turned off.

5. The circuit breaker according to claim 1, wherein:
the first circuit includes the first mechanical switch connected in series with the first bidirectional semiconductor switch; and
the second circuit includes a third bidirectional semiconductor switch connected in series with the second bidirectional semiconductor switch;
during normal operation, the first mechanical switch and the first bidirectional semiconductor switch are turned on and the second bidirectional semiconductor switch and the third bidirectional semiconductor switch are turned on to pass the normal current through the first circuit and the second circuit.;
when a fault occurs in the load, the first bidirectional semiconductor switch, the second bidirectional semiconductor switch and the third bidirectional semiconductor switch are turned off;
when a fault occurs in the first bidirectional semiconductor switch, the first mechanical switch is opened to pass the normal current for the load through the second circuit, and, thereafter, either normal operation is continued or, after insulation of the first mechanical switch recovers, at least one of the second bidirectional semiconductor switch and the third bidirectional semiconductor switch is turned off;
when a fault occurs in the second bidirectional semiconductor switch, the third bidirectional semiconductor switch is turned off to pass the normal current for the load through the first circuit to continue normal operation, or the third bidirectional semiconductor switch and the first bidirectional semiconductor switch are turned off; and
when a fault occurs in the third bidirectional semiconductor switch, the second bidirectional semiconductor switch is turned off to pass the normal current for the load through the first circuit to continue normal operation, or the second bidirectional semiconductor switch and the first bidirectional semiconductor switch are turned off.

6. The circuit breaker according to claim 1, designed in such a manner that:
a product of a fault rate of the load and a fault rate of the first bidirectional semiconductor switch is less than 10\hat{ }-9/hour; and
a product of the fault rate of the load and a fault rate of the second bidirectional semiconductor switch is less than 10\hat{ }-9/hour.

7. The circuit breaker according to claim 6, further comprising:
a fault diagnosis unit adapted to regularly perform a fault diagnosis process for the first bidirectional semiconductor switch and the second bidirectional semiconductor switch.

8. The circuit breaker according to claim 7, wherein:
a product of the fault rate of the load, a nominal value of the fault rate of the first bidirectional semiconductor switch and 1/K1 is less than 10\hat{ }-9/hour; and
a product of the fault rate of the load, a nominal value of the fault rate of the second bidirectional semiconductor switch and 1/K2 is less than 10\hat{ }-9/hour,
where:
K1 is the number of times the fault diagnosis process for the first bidirectional semiconductor switch is performed per hour; and
K2 is the number of times the fault diagnosis process for the second bidirectional semiconductor switch is performed per hour.

9. The circuit breaker according to claim 5, further comprising:
a fault diagnosis unit adapted to regularly perform a fault diagnosis process for the first bidirectional semiconductor switch, the second bidirectional semiconductor switch, and the third bidirectional semiconductor switch.

10. The circuit breaker according to claim 7, wherein:
the fault diagnosis unit successively performs, during normal operation: an operation in which the first bidirectional semiconductor switch is turned on and the second bidirectional semiconductor switch is turned off to pass the normal current through the first circuit; and an operation in which the first bidirectional semiconductor switch is turned off and the second bidirectional semiconductor switch is turned on to pass the normal current through the second circuit, and performs the fault diagnosis process based on at least one of a current in the first circuit or a current in the second circuit during the associated operation.
